(19) United States
(12) Patent Application Publication
(10) Pub. No.: US 2002/0095461 A1
(43) Pub. Date: Jul. 18, 2002

(54) Apparatus and method for conducting auction via network

(75) Inventor: Tsukasa Ooishi, Hyogo (JP)

Correspondence Address: McDERMOTT, WILL & EMERY, 600 13th Street, N.W., Washington, DC, 20005-3096, US

(73) Assignee: MITSUBISHI DENKI KABUSHIKI KAISHA

(21) Appl. No.: 09/905,921

(22) Filed: Jul. 17, 2001

(30) Foreign Application Priority Data
Jan. 15, 2001 (JP) 2001-006376(P)

(51) Int. Cl. G06F 15/16; G06F 17/60

(52) U.S. Cl. 709/204; 705/37

(57) ABSTRACT

In a database disposed on a server side, data of an indefinite number of clients is stored. The server has the function of storing data to the database, a searching function, a reproducing function, an auction conducting function, and the like. Data as an object of unconditional buying and selling in the stored data is sold at a price designated by the owner, and data to be auctioned in the storage data is put up for auction conducted among a plurality of clients.

### BACKGROUND OF THE INVENTION

1. Field of the Invention

The present invention relates to an apparatus and method for conducting an auction among an indefinite number of clients via a network.

2. Description of the Background Art

A conventional auction system will be described by referring to FIG. 14. At a site of a conventional auction, each of bidders X, Y, and Z is allowed to make a bid for an object A to be auctioned in a predetermined period, and the object A is sold to the bidder whose bid is the highest.

In a conventional auction, however, the auctioneer and bidders have to show the intention of participating in an auction in advance. That is, in the conventional auction, the process is not flexible.

### SUMMARY OF THE INVENTION

The present invention therefore provides an apparatus and method capable of conducting an auction via a network among an indefinite number of clients at a higher degree of freedom.

A server computer for conducting an auction via a network according to an aspect of the invention, the server computer being connected to an indefinite number of clients via the network, has: a database for storing data of the indefinite number of clients; and a processor having functions of storing data received via the network into the database, searching the database at a retrieval request from any of the indefinite number of clients, and putting data stored in the database up for auction on the network among the indefinite number of clients at a request of the owner of the data.

Preferably, the auction includes an event auction conducted at the time point when a purchase order from any of the clients is received via the network for the first time. Data stored in the database includes information indicating whether or not the data is put up for the event auction, and the processor conducts the event auction for determining a client to which the data is distributed in accordance with a bid received via the network on the basis of the information.

Preferably, the auction includes an open auction periodically held. Data stored in the database includes information indicating whether or not the data is put up for the open auction, and the processor conducts the open auction for determining a client to which the data is distributed in accordance with a bid received via the network on the basis of the information.

Preferably, the processor further has a function of distributing data stored in the database via the network at a price presented by the owner of the data at a request of the owner of the data.

Preferably, the processor further has a function of transmitting data stored in the database via the network to the owner of the data at a request of the owner of the data.

Preferably, the processor further has a function of periodically inquiring via the network a client as the owner of the data whether the storage is renewed or not and renewing or discarding the data in accordance with a request of the owner of the data.

Preferably, data stored in the database includes detailed data of contents and outline data indicative of an outline of the contents, and the processor transmits the outline data as a result of the retrieval to a corresponding client.

A method of conducting an auction via a network according to another aspect of the invention, includes the steps of: storing data of an indefinite number of clients received via a network into a database;

searching the database at a search request from any of the indefinite number of clients received via the network; and putting data stored in the database up for auction conducted among the indefinite number of clients at a request of the owner of the data.

Preferably, the auction includes an event auction conducted at the time point when a purchase order from any of the clients is received for the first time via the network. Data stored in the database includes information indicating whether the data is put up for the event auction or not, and in the step of conducting the auction, on the basis of the information, the event auction for determining a client to which the data is distributed in accordance with a bid received via the network is conducted.

Preferably, the auction includes an open auction periodically held. Data stored in the database includes information indicating whether the data is put up for the open auction or not, and in the step of conducting the auction, on the basis of the information, the open auction for determining a client to which the data is distributed in accordance with a bid received via the network is conducted.

Preferably, the method further includes a step of selling data stored in the database via the network at a price presented by the owner of the data at a request of the owner of the data.

Preferably, the method further includes a step of transmitting data stored in the database via the network to the owner of the data at a request of the owner of the data.

Preferably, the storing step further includes a step of periodically inquiring via the network a client as the owner of the data whether the storage is renewed or not and renewing or discarding the data in accordance with a request of the owner of the data.

Preferably, data stored in the database includes detailed data of contents and outline data of the contents, and the searching step further includes a step of transmitting the outline data as a result of the search to a corresponding client.

A program product for an auction conducted via a network according to further another aspect of the invention allows a computer to execute: a communicating process for transmitting/receiving data to/from an indefinite number of clients via the network; a storing process for storing data of the indefinite number of clients received via the network into a database; a searching process for searching the database at a search request from any of the indefinite number of clients received via the network; and a process for putting data stored in the database up for auction on the network among the indefinite number of clients at a request of the owner of the data.

Preferably, the auction includes an event auction conducted at a time point when a purchase order from any of the clients is received for the first time via the network.

Preferably, the auction includes an open auction periodically held.

Particularly, data stored in the database includes information indicating whether the data is put up for auction or not and, in the process of conducting the auction, on the basis of the information, a client to which the data is distributed is determined in accordance with a bid received via the network.

Particularly, data stored in the database includes information indicating whether the data is put up for the open auction or not, and in the process of conducting the auction, on the basis of the information, a client to which the data is distributed is determined in accordance with a bid received via the network.

Preferably, the program product further allows the computer to execute a process for distributing data stored in the database via the network at a price presented by the owner of the data at a request of the owner of the data.

Preferably, the program product further allows the computer to execute a process for transmitting data stored in the database via the network to the owner of the data at a request of the owner of the data.

Particularly, in the storing process, the program product further allows the computer to execute a process of periodically inquiring via the network a client as the owner of the data whether the storage is renewed or not and renewing or discarding the data in accordance with a request of the owner of the data.

Preferably, data stored in the database includes detailed data of contents and outline data of the contents, and the computer is further allowed to execute a process of transmitting the outline data as a result of the search to a corresponding client via the communicating process.

As described above, in the server, client, system, method, and program product for conducting an auction according to the invention, the client can store its data in the database on the server side. The stored data can be always read until a request of discarding the data is made.

A client can purchase contents data of another person stored in the database at a designated price. The client can purchase contents data of another person stored in the database by an auction. An auction conducted periodically or by a purchase request as a trigger is conducted at a request of the owner of the data.

Therefore, contents data can be sold/bought among an indefinite number of clients at a high degree of freedom.

Data is encoded and the encoded data is distributed, so that an unauthorized act such as falsification of contents data can be prevented.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram for explaining the flow of data in an embodiment of the invention;

FIG. 2 is a diagram for explaining the outline of a system according to the embodiment of the invention;

FIG. 3 is a diagram for explaining the structure of storage data stored in a database 101;

FIG. 4 is a diagram for explaining a sequence since data is stored until the data is discarded in the embodiment of the invention;

FIG. 5 is a flowchart for explaining a sequence since data is stored until the data is discarded;

FIG. 6 is a flowchart for explaining a sequence of reproducing stored data in the embodiment of the invention;

FIG. 7 is a diagram for explaining services provided when data retrieval is requested in the embodiment of the invention;

FIG. 8 is a flowchart for explaining a sequence of processes performed at a data retrieval request;

FIG. 9 is a diagram for explaining an event auction in the embodiment of the invention;

FIG. 10 is a flowchart for explaining the flow of an event auction;

FIG. 11 is a flowchart for explaining the flow of an open auction according to the embodiment of the invention;

FIG. 12 is a block diagram showing an example of the configuration of a server 100;

FIG. 13 is a block diagram showing an example of the configuration of a client; and

FIG. 14 is a diagram for explaining a conventional auction.

### DESCRIPTION OF THE PREFERRED EMBODIMENT

An embodiment of the invention will be described hereinbelow with reference to the drawings. The same or corresponding components in the drawings are designated by the same reference numerals and their description will not be repeated.

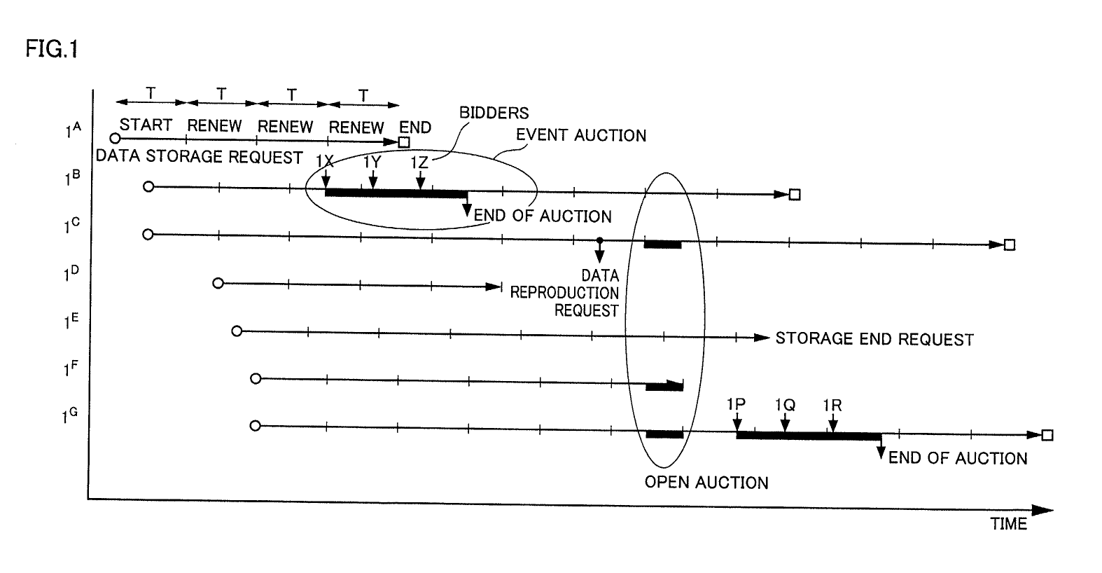

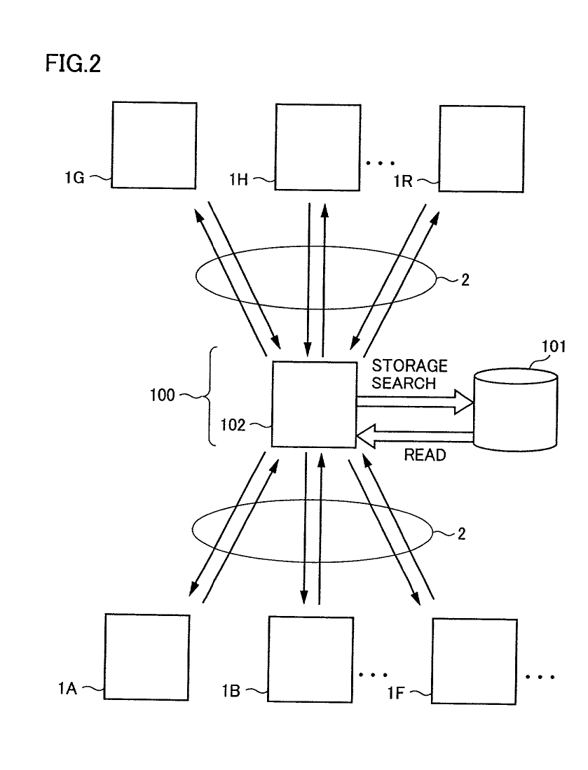

The general outline of a system in an embodiment of the invention will be described by referring to FIGS. 1 to 3. An indefinite number of clients 1A to 1R are connected to a server 100 via networks 2. The clients include general users and contents vendors.

The server 100 includes a database 101 and a processor 102 for processing data. In the database 101, data of the clients is stored. The processor 102 has the function of storing data to the database 101, the function of searching the database 101, the function of reading data from the database 101, the auction function which will be described hereinlater, the function of transmitting/receiving data, and the like.

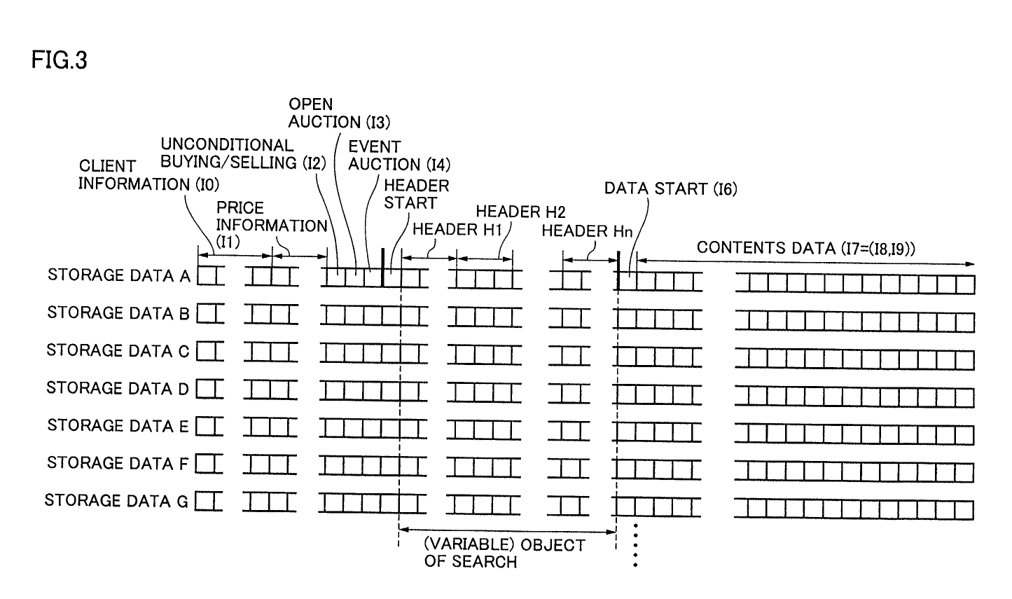

Data to be recorded in the database 101 includes, as shown in FIG. 3, client information 10 including information of the owner of the stored data, price information I1 indicative of price in unconditional buying and selling, unconditional buying and selling information I2 indicating whether the data is an object of unconditional buying and selling or not, open auction information I3 indicating whether the data is an object of an open auction or not, event auction information I4 indicating whether the data is an object of an event auction or not, header start position I5 indicative of the start position of a header, headers Hi for search (1≦i≦n), data start position I6 indicative of the start position of contents data I7, and the contents data I7 having outline data of the contents and detailed data of the contents.

When a data storage request is received from a client via the network 2, the server 100 stores the data of the client to the database 101. Data storage requests are sent from an indefinite number of clients to the server 100 at different time bases. In FIG. 1, blank circles (sign o) represent timings of the data storage requests.

The storage data is updated every predetermined time T. The stored data is discarded on receipt of a storage end request from the client as the owner of the storage data. Boxes in FIG. 1 represent timings of discarding data (end).

When a reproduction request for reproducing data of a client is received from the client, the server 100 reads the corresponding storage data from the database 101 and transmits it to the client. That is, the client can freely takes its storage data and reproduces it.

A client can purchase retrieved storage data of the other clients.

Data as an object of unconditional buying and selling in the storage data can be purchased at a price specified by the owner.

Data as an object of auction in the storage data can be purchased by an auction conducted among a plurality of clients. In an auction, the price of storage data is determined by the highest bid and the data is distributed to the client as a successful bidder via a network.

Auctions include an open auction periodically held by the server 100, and an event auction held when a purchase order is received from a client.

The server 100 performs an auction conducting process at a client's wish (open auction information I3 and event auction information I4).

FIG. 1 shows a case where data of a client 1B is an object of an event auction, and data of each of clients 1C, 1F, and 1G is an object of an open auction.

At the time point a client 1X bids for the data of the client 1B, the server 100 starts an event auction. The event auction is held for a predetermined period. When clients 1Y and 1Z bid for the data during the period, the server 100 determines the client to which the data of the client 1B is sold on the basis of the bids.

The data of the clients 1C, 1F, and 1G as objects of an open auction is auctioned for a predetermined time. When clients 1P, 1Q, and 1R as bidders bid for the data of the client 1G, the server 100 determines the client to which the data of the client 1G is sold on the basis of the bids.

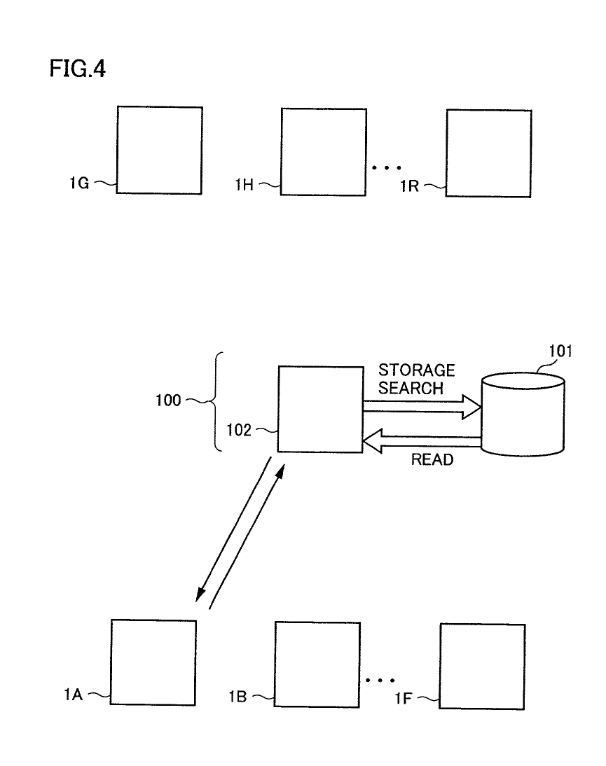

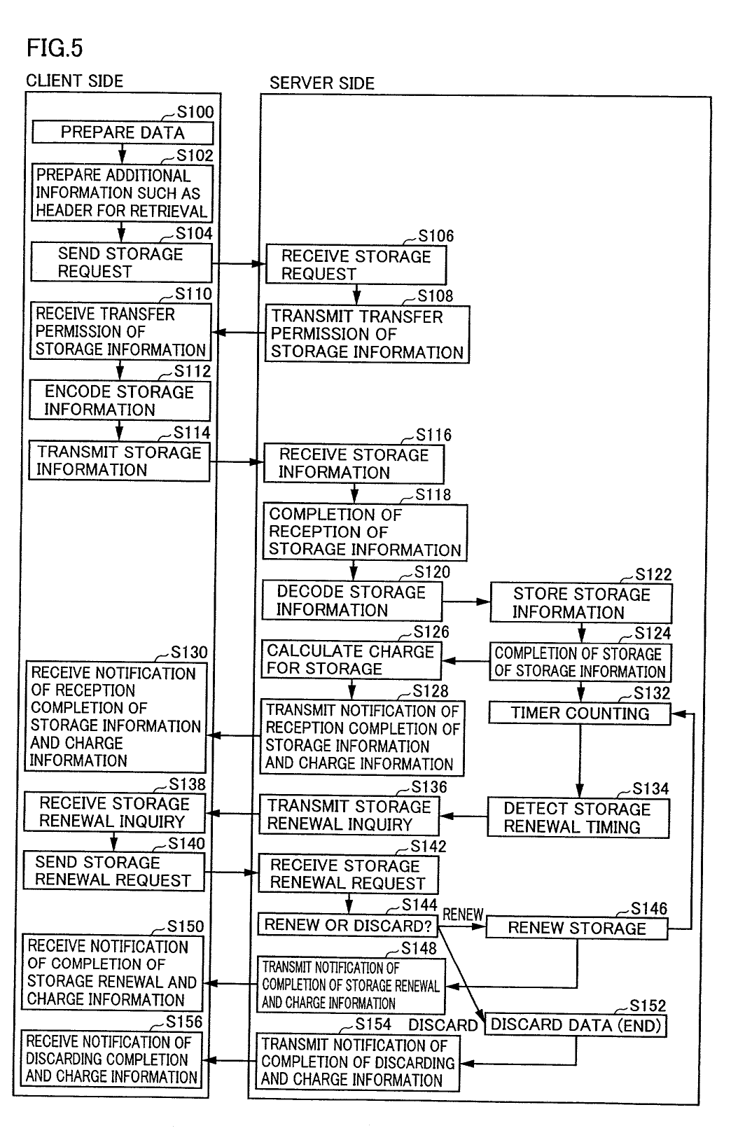

The sequence from a data storage request to discarding of stored data will now be described by referring to FIGS. 4 and 5. As shown in FIG. 4, it is assumed that the client 1A requests the server 100 to store data.

First, the client 1A prepares detailed contents data desired to be stored (S100) and adds additional information and header information for retrieval to the data desired to be stored (S102).

The client 1A transmits a storage request to the server 100 (S104). When the storage request from the client 1A is received (S106), the server 100 sends transfer permission of the storage information to the client 1A (S108).

On receipt of the transfer permission of storage information (S110), the client 1A encodes the storage information (data including contents data, header, and additional information) (S112), and transmits the encoded storage information to the server 100 (S114).

The server 100 receives the storage information (S116). After completion of reception of the storage information (S118), the server 100 decodes the storage information (S120) and stores the resultant to the database (S122).

After completion of storage of the storage information into the database (S124), the server 100 calculates a charge for the storage (S126).

The server 100 sends a notification of reception completion of the storage information and charge information to the client 1A (S128).

The client 1A receives the notification of reception completion of the storage information and the charge information (S130), thereby confirming that the information is stored.

After completion of the storage of the storage information, the server 100 starts counting storage time by using a built-in timer (S132). When the storage time reaches specific time (detection of storage update timing) (S134), to inquire extension of the storage, the server 100 sends a storage renewal inquiry to the client 1A (S136).

The client 1A receives the storage renewal inquiry from the server 100 (S138), and transmits a storage renewal request to answer the inquiry to the server 100 (S140).

When the storage renewal request from the client 1A is received (S142), the server 100 determines whether the information storage is to be renewed (extended) or discarded from the storage renewal request (S144).

In the case of renewal, the server 100 renews the storage (S146) and starts counting the timer (S132). The server 100 sends a notification of completion of storage renewal and charge information for renewing the storage to the client 1A (S148).

The client 1A receives the notification of completion of the storage renewal and the charge information from the server 100 (S150), thereby confirming that the data is continuously stored.

In the case of discarding the data, the server 100 discards the stored data (end of storage) (S152) and sends a notification of completion of the discarding and charge information (S154). The client 1A receives the discarding completion notification and the charge information from the server 100 (S156), thereby confirming that the discarding has been completed.

In such a manner, the client (user) can store its data in the server 100. The server 100 inquires the client about extension of the storage every predetermined period and stores the storage data until an instruction of discarding the data is given from the client. The server 100 continuously stores the data of the client, and finishes the storage by the intention of the client.

The charge may be variously determined, for example, by adding a basic set charge for recording and a charge depending on a storage period.

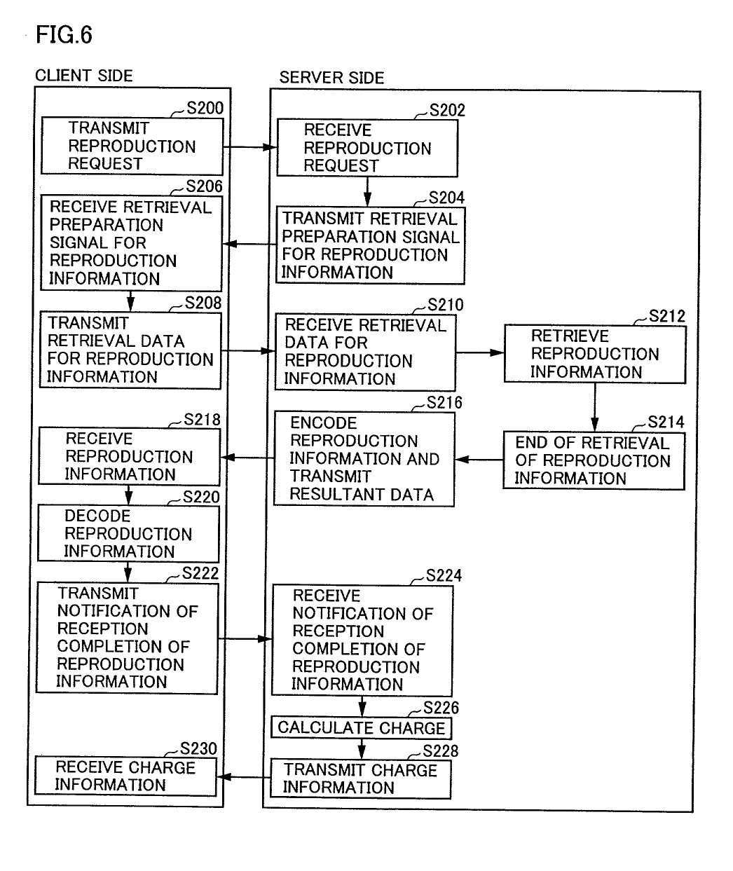

A reproduction service sequence for reproducing the storage data will now be described by referring to FIG. 6. It is assumed that the client 1A wishes to reproduce its data stored in the database 101.

First, the client 1A transmits a reproduction request to the server 100 (S200). When the reproduction request from the client 1A is received (S202), the server 100 transmits a retrieval preparation signal for extracting storage data (reproduction information) desired by the client to be reproduced (S204).

When the retrieval preparation signal for reproduction information is received from the server 100 (S206), the client 1A transmits retrieval data to the server 100 (S208).

On receipt of the retrieval data from the client 1A (S210), the server 100 retrieves the reproduction information from the information stored in the database 101 on the basis of the retrieval data (S212). When the retrieval of the reproduction information is completed (S214), the server 100 encodes the reproduction information and transmits it to the client 1A (S216).

The client 1A receives the encoded reproduction information (S218), decodes it (S220), and transmits a notification of reception completion of the reproduction information to the server 100 (S222).

When the notification of reception completion of the reproduction information is received from the client 1A (S224), the server 100 calculates a charge for the reproduction service (S226). The server 100 sends charge information to the client 1A (S228), and the client 1A receives the charge information from the server 100 (S230).

In such a manner, a client can always reproduce its data stored on the server side.

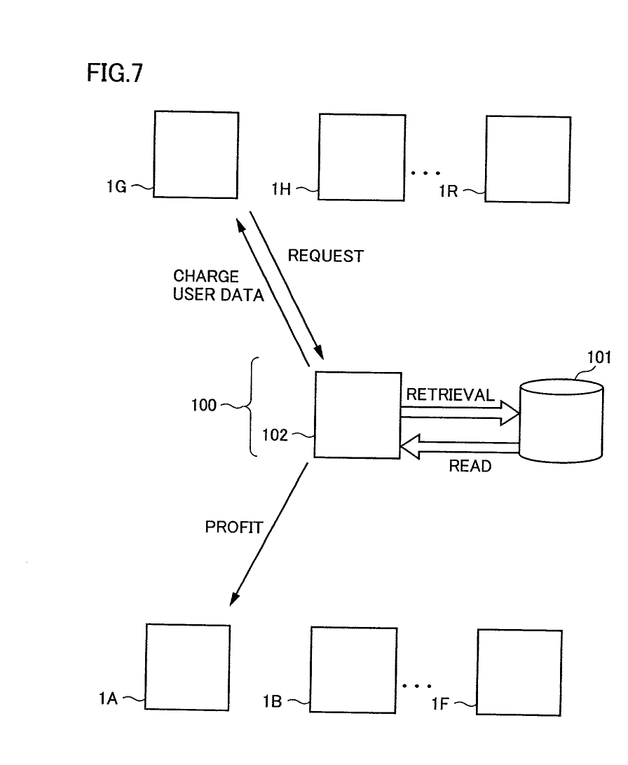

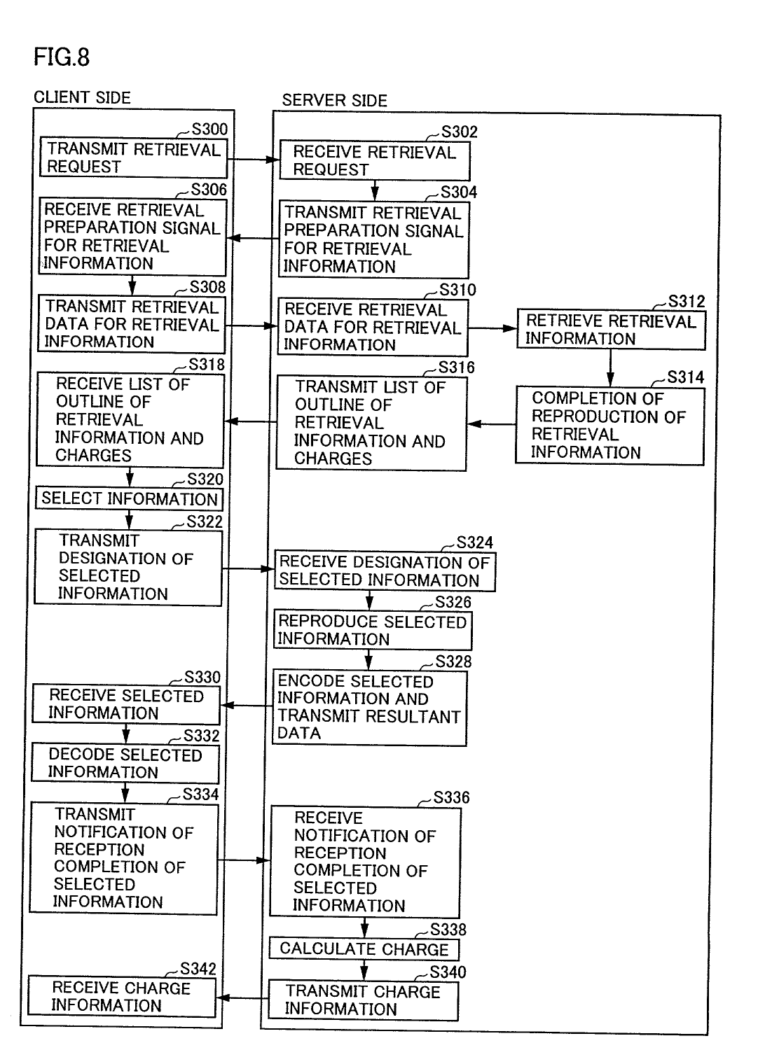

A sequence of service provided when data retrieval is requested will now be described by referring to FIGS. 7 and 8. As shown in FIG. 7, it is assumed that storage data of the client 1A as an object of unconditionally buying and selling is retrieved at the retrieval request of the client 1G.

First, the client 1G sends the retrieval request to the server 100 (S300). On receipt of the retrieval request from the client 1G (S302), the server 100 transmits a retrieval preparation signal for extracting the storage data (retrieval information) desired by the client (S304).

When the retrieval preparation signal for retrieval information is received from the server 100 (S306), the client 1G transmits the retrieval data to the server 100 (S308).

The server 100 receives the retrieval data from the client 1G (S310) and selects the applicable retrieval information on the basis of the retrieval data and a header included in the data stored in the database 101 (S312).

The server 100 reproduces the retrieval information. Specifically, outline data I8, price information I1, unconditional buying/selling information I2, open auction information I3, and event auction information I4 included in the retrieval information is read (S314).

The server 100 sends a list of the outline data I8 as an outline of the retrieval information and charges (information I1 to I4) to the client 1G (S316).

The client 1G receives the list of the outline of the retrieval information and the charges from the server 100 (S318) and selects information (selected information) that the client 1G wishes to purchase from the retrieval information (S320). In this case, it is assumed that the client 1G selects data of the client 1A as an object of unconditional buying/selling indicated by the unconditional buying/selling information I2. The client 1G transmits a signal for designating the selected information to the server 100 (S322).

When the signal for designating the selected information is received from the client 1G (S324), the server 100 reproduces the selected information. Specifically, all of data constructing the selected information is read from the database 101 (S326). The server 100 encodes the selected information and transmits the encoded information to the client 1G (S328).

The client 1G receives the encoded selection information from the server 100 (S330), decodes it (S332), and sends a notification of reception completion of the selection information to the server 100 (S334).

When the notification of reception completion of the selected information is received from the client 1G (S326), the server 100 calculates the charge for the retrieval service (S338). Specifically, a charge corresponding to the amount designated by the price information I1 of the selected information is calculated.

The server 100 transmits the charge information including the result of the charge calculation to the client 1G (S340), and the client 1G receives the charge information from the server 100 (S342).

After that, the desired data is distributed from the server 100 to the client 1G. In such a manner, an indefinite number of clients can purchase of the copyright of contents data owned by another person as an object of unconditional buying and selling at a sales price designated by the another person. An indefinite number of clients can sell data at a designated price. A payment method of the charge to the client is not limited here.

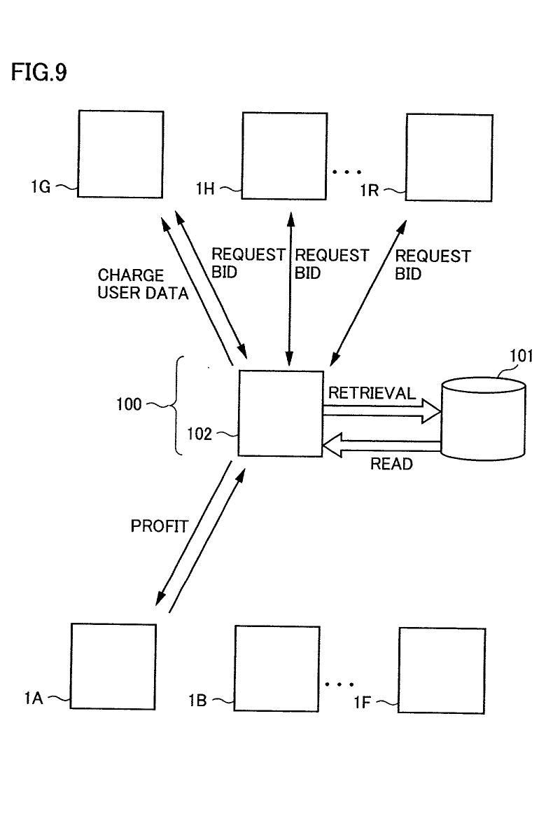

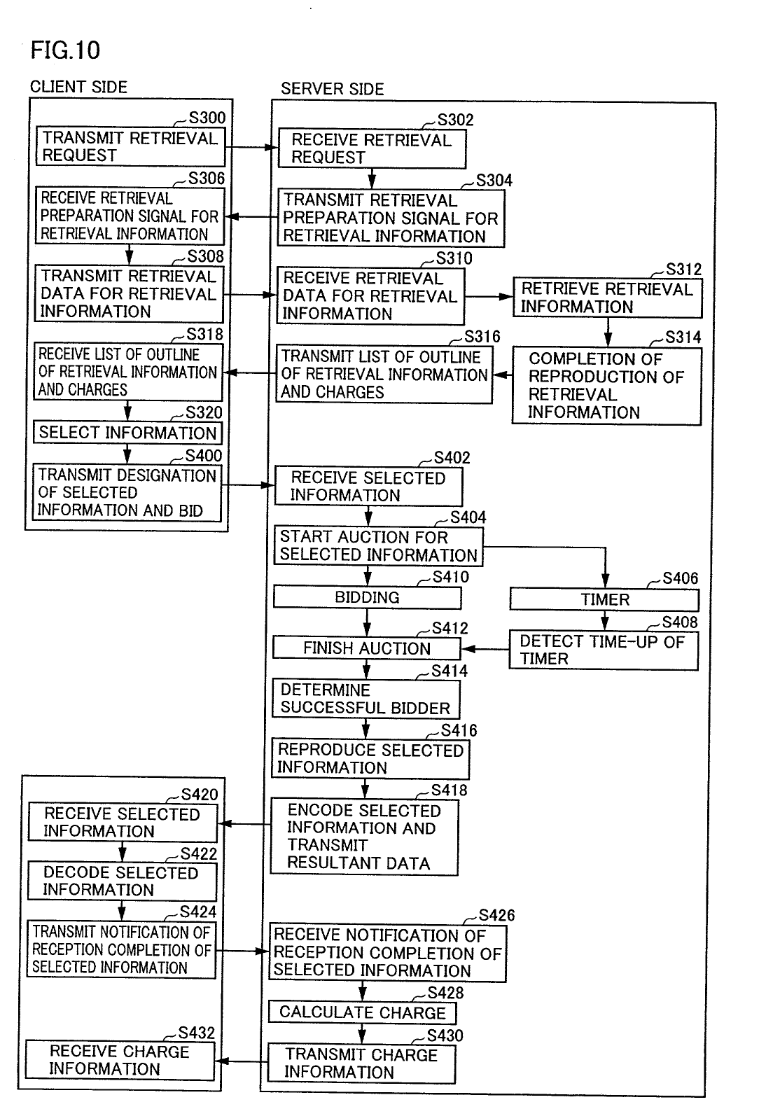

A sequence of an event auction will now be described by referring to FIGS. 9 and 10. As shown in FIG. 9, it is assumed that information selected by the client 1G is an object of an event auction, and the clients 1G, 1H, . . . bid for the selected information.

The sequence from transmission (S300) of a retrieval request of the client 1G to selection (S320) of information that the client 1G desires to purchase in the retrieval information is as described in the sequence of data retrieval request. In this case, it is assumed that the client 1G selects the data of the client 1A as an object of an event auction indicated by the event auction information I4. The client 1G sends a signal of designating the selected information and a bid to the server 100 (S400).

When the designation of the selected information and the bid are received from the client 1G (S402), the server 100 starts conducting an event auction for the selected information (S404).

The event auction is held for only a predetermined period from the start of the auction. On start of the event auction, the server 100 starts counting the period by using the built-in timer (S406).

Until the end of the event auction is detected by the timer (S408), the server 100 accepts requests of purchasing the selected information to be auctioned from the other clients (S410). Specifically, the server 100 accepts the designation of the selected information and a bid from each of an indefinite number of clients. It is assumed that the clients 1G, 1H, . . . bid.

When the termination of the period of the event auction is detected (S408), the server 100 finishes the event auction (S412). The server 100 determines a successful client on the basis of the bids sent from the clients 1G, 1H, . . . (S414). It is assumed that the client 1G who made the highest bid is a successful one.

The server 100 reproduces the selected information. Specifically, the server 100 reads all of data constructing the selected information from the database (S416). The server 100 encodes the selected information and transmits the encoded selected information to the client 1G (S418).

The client 1G receives the encoded selected information from the server 100 (S420), decodes it (S422), and transmits a notification of reception completion of the selected information to the server 100 (S424).

When the notification of reception completion of the selected information from the client 1G is received (S426), the server 100 calculates a charge according to the bid (S428).

The server 100 sends the charge information including the result of the charge calculation to the client 1G (S430), and the client 1G receives the charge information from the server 100 (S432).

After that, the desired data is distributed from the server 100 to the client 1G. The charge according to the bid is paid to the client 1A. A payment method is not limited here.

As described above, data desired to be event-auctioned is put up for auction to an indefinite number of clients for a predetermined period since a client who wishes to purchase the data appears first. The copyright of the contents data is given to the client who makes the highest bid.

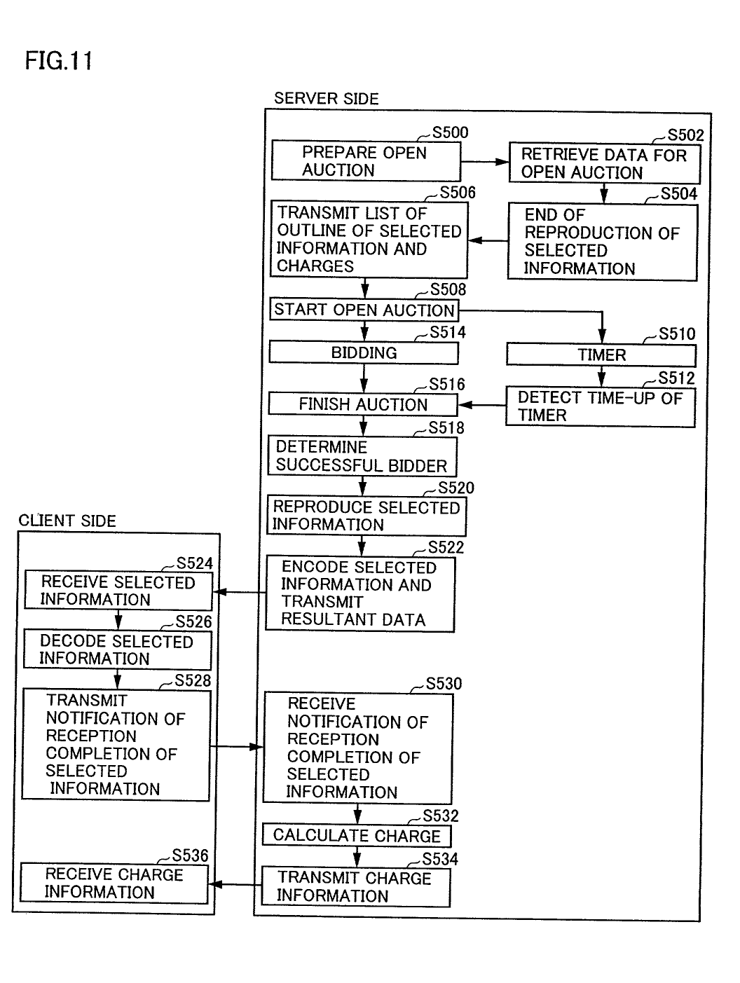

A sequence of an open auction will now be described by using FIG. 11. An open auction is periodically conducted by the server 100. It is assumed that data stored in the client 1A is an object of an open auction and the clients 1G, 1H, . . . bid for the data.

The server 100 prepares for the open auction (S500). The server 100 retrieves data to be put up for open auction (selected information) from data stored in the database (S502). Whether the information is an object or not is determined by the open auction information 13. The server 100 reproduces the selected information (S504). Specifically, the outline data I8, price information I1, unconditional buying/selling information I2, open auction information I3, and event auction information I4 included in the selected information is read.

The server 100 sends a list of the outline data I8 as an outline of the selected information and charges (information I1 to I4) to an indefinite number of clients (S506) and starts the open auction (S508).

The open auction is held only for a predetermined period since the auction starts. On start of the open auction, the server 100 starts counting the period by using the built-in timer (S510).

Until the end of the open auction is detected by the timer (S512), purchase requests of the selected information as an object to be auctioned from an indefinite number of clients are accepted (S514).

To be specific, the designation of the selected information and a bid of each of the indefinite number of clients are received (the processes in S300 to S320 and S400 or the process in S400).

On detection of the termination of the period of the open auction (S512), the server 100 finishes the open auction (S516). The server 100 determines a successful client on the basis of the bids sent from the clients (S518). It is assumed that a successful bidder is the client 1G which made the highest bid.

The server 100 reproduces the selected information. Specifically, the server 100 reads all of the data constructing the selected information from the database 101 (S520). The server 100 encodes the selected information and transmits the encoded selected information to the client 1G (S522).

The client 1G receives the encoded selected information from the server 100 (S524), decodes it (S526), and transmits a notification of reception completion of the selected information to the server 100 (S528).

When the notification of reception completion of the selected information is received from the client 1G (S530), the server 100 calculates a charge according to the bid (S532).

The server 100 sends the charge information including the result of the charge calculation to the client 1G (S534), and the client 1G receives the charge information from the server 100 (S536).

After that, the desired data is distributed from the server 100 to the client 1G. The charge according to the bid is paid to the client 1A. A payment method is not limited here.

As described above, data desired to be open-auctioned is put up for auction to an indefinite number of clients for a predetermined period. The copyright of the contents data is given to a client who presents the highest bid.

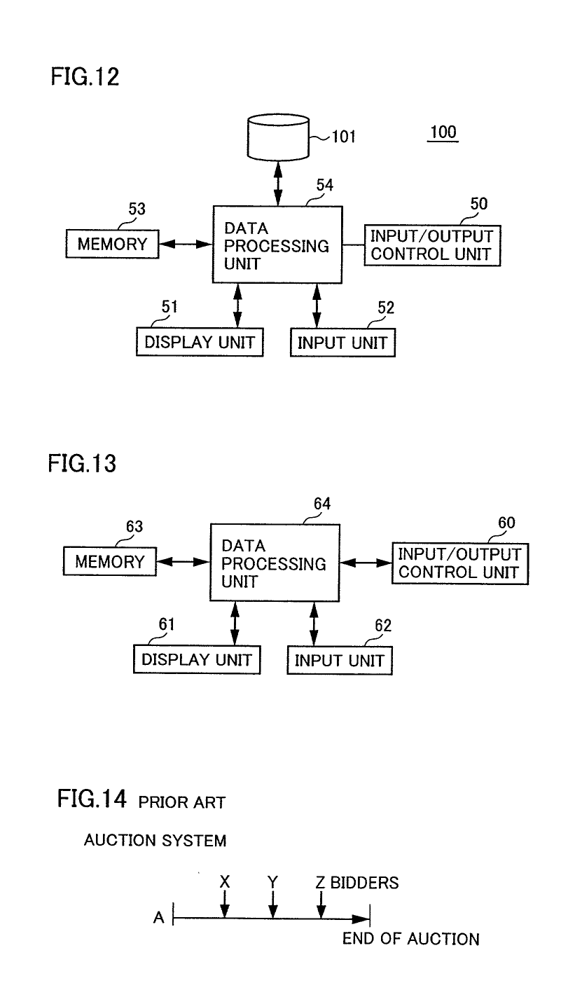

FIG. 12 illustrates an example of the configuration of the server 100. The server 100 includes, as shown in FIG. 12, an input/output control unit 50 for receiving/transmitting data via the network 2, a display unit 51 for displaying data, an input unit 52 for receiving data, a memory 53, a data processing unit 54 for performing the above-described data storing function, data retrieving function, data reading function, and auction conducting function and controlling the components, and the database 101.

FIG. 13 shows an example of the configuration of the client. The client includes, as shown in FIG. 13, an input/output control unit 60 for receiving/transmitting data via the network 2, a display unit 61 for displaying data, an input unit 62 for receiving data, a memory 63, and a data processing unit 64 for performing functions of the above-described retrieval request, reproduction request, designation of selected information, bidding, issuing a notification of reception completion, and the like and controlling the components.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A server for conducting an auction via a network connecting clients, comprising:
a database for storing data of said clients; and
a processor having functions of storing data received via said network into said database, searching said database at a retrieval request from said clients, and putting data stored in said database up for auction on said network among said clients at a request of the owner of said data.

2. The server according to claim 1, wherein said auction includes an event auction started to be held at the time when a purchase order from any of the clients is received via said network for the first time.

3. The server according to claim 1, wherein said auction includes an open auction periodically held.

4. The server according to claim 1, wherein said processor further has a function of distributing data stored in said database via said network at a price presented by the owner of said data at a request of the owner of said data.

5. The server according to claim 1, wherein said processor further has a function of transmitting data stored in said database via said network to the owner of said data at a request of the owner of said data.

6. The server according to claim 1, wherein said processor further has a function of periodically inquiring via said network a client as the owner of said data whether the storage is renewed or not and renewing or discarding the data in accordance with a request of the owner of said data.

7. A method of conducting an auction via a network, comprising the steps of:
storing data of clients received via a network into a database;
searching said database at a search request from said clients received via said network; and
putting data stored in said database up for auction on said network among said clients at a request of the owner of said data.

8. The method according to claim 7, wherein said auction includes an event auction conducted at the time point when a purchase order from any of the clients is received for the first time via said network.

9. The method according to claim 7, wherein said auction includes an open auction periodically held.

10. The method according to claim 7, further comprising a step of selling data stored in said database via said network at a price presented by the owner of said data at a request of the owner of said data.

11. The method according to claim 7, further comprising a step of transmitting data stored in said database via said network to the owner of said data at a request of the owner of said data.

12. The method according to claim 7, wherein said step of storing further comprises a step of periodically inquiring via said network a client as the owner of said data whether the storage is renewed or not and renewing or discarding the data in accordance with a request of the owner of said data.

13. A program product for an auction conducted via a network, for allowing a computer to execute:
a communicating process for transmitting/receiving data to/from said clients via said network;
a storing process for storing data of said clients received via said network into a database;
a searching process for searching said database at a search request from said clients received via said network; and
a process for putting data stored in said database up for auction on said network among said clients at a request of the owner of said data.

14. The program product according to claim 13, wherein said auction includes an event auction conducted at a time point when a purchase order from any of the clients is received for the first time via said network.

15. The program product according to claim 13, wherein said auction includes an open auction periodically held.

16. The program product according to claim 13, further for allowing said computer to execute a process for distributing data stored in said database via said network at a price presented by the owner of said data at a request of the owner of said data.

17. The program product according to claim 13, further for allowing said computer to execute a process for transmitting data stored in said database via said network to the owner of said data at a request of the owner of said data.

18. The program product includes according to claim 13, wherein said storing process includes a process of periodically inquiring via said network a client as the owner of said data whether the storage is renewed or not and renewing or discarding the data in accordance with a request of the owner of said data.
